(19) United States
(12) Patent Application Publication
(10) Pub. No.: US 2019/0234265 A1
(43) Pub. Date: Aug. 1, 2019

(54) GASOLINE PARTICULATE FILTER ON-BOARD DIAGNOSTIC TECHNIQUES USING OXYGEN SENSOR HEATER

(71) Applicants: Edward E Baker, Livonia, MI (US); Robert Jerger, Dexter, MI (US); James J Daley, Jackson, MI (US); John R Jaye, Northville, MI (US); Roger C Sager, Munith, MI (US); Joseph M Dekar, Jackson, MI (US); Mark L Lott, Webberville, MI (US); Brian L Terwedo, Okemos, MI (US); Jospeh B Unsworth, Ann Arbor, MI (US); Jordan E Easter, Ann Arbor, MI (US); Luis J Del Rio, Ann Arbor, MI (US); Wei-Jun Yang, Ypsilanti, MI (US); Lydell S Powell, West Bloomfield, MI (US); Xuefei Chen, Novi, MI (US); Andrew Brocker, Brighton, MI (US)

(72) Inventors: Edward E Baker, Livonia, MI (US); Robert Jerger, Dexter, MI (US); James J Daley, Jackson, MI (US); John R Jaye, Northville, MI (US); Roger C Sager, Munith, MI (US); Joseph M Dekar, Jackson, MI (US); Mark L Lott, Webberville, MI (US); Brian L Terwedo, Okemos, MI (US); Jospeh B Unsworth, Ann Arbor, MI (US); Jordan E Easter, Ann Arbor, MI (US); Luis J Del Rio, Ann Arbor, MI (US); Wei-Jun Yang, Ypsilanti, MI (US); Lydell S Powell, West Bloomfield, MI (US); Xuefei Chen, Novi, MI (US); Andrew Brocker, Brighton, MI (US)

(21) Appl. No.: 15/886,456

(22) Filed: Feb. 1, 2018

(51) Int. Cl. F01N 3/023; F02M 35/024; G01N 27/26; F01N 11/00; F02D 41/02

(52) U.S. Cl. CPC F01N 3/023; F02M 35/024; F02D 41/029; F01N 11/007; G01N 27/26

(57) ABSTRACT

A diagnostic system and method for a gasoline particulate filter (GPF) of an exhaust system of a vehicle comprise at least one heater associated with at least one oxygen (O2) sensor disposed proximate to the GPF in the exhaust system and a controller configured to determine a status of the GPF based on a duty cycle of the at least one O2 sensor heater and, based on the determined status of the GPF, detect a malfunction of the GPF or whether to regenerate the GPF.

### FIELD

The present application generally relates to exhaust on-board diagnostic (OBD) monitoring and, more particularly, to OBD techniques for a gasoline particulate filter (GPF) using an oxygen (O2) sensor heater.

### BACKGROUND

An internal combustion engine combusts a mixture of air and fuel (e.g., gasoline) within cylinders to drive pistons that generate drive torque at a crankshaft. Exhaust gas resulting from combustion is expelled from the cylinders into an exhaust system that treats the exhaust gas to decrease or eliminate emissions. One exhaust gas constituent is particulate matter (e.g., ash or soot) that is trapped by a device commonly referred to as a gasoline particulate filter (GPF). When the GPF approaches a load threshold, the GPF is regenerated by burning off the trapped particulate matter. Emissions regulations require on-board diagnostic (OBD) monitoring of the state of the GPF for regeneration scheduling and malfunction detection. Conventional GPF diagnostic systems require additional components that are expensive and increase vehicle costs. Accordingly, while such vehicle diagnostic systems work well for their intended purpose, there remains a need for improvement in the relevant art.

### SUMMARY

According to one example aspect of the invention, a diagnostic system for a gasoline particulate filter (GPF) of an exhaust system of a vehicle is presented. In one exemplary implementation, the system comprises: at least one heater associated with at least one oxygen (O2) sensor disposed proximate to the GPF in the exhaust system and a controller configured to: determine a status of the GPF based on a duty cycle of the at least one O2 sensor heater, and based on the determined status of the GPF, detect a malfunction of the GPF or whether to regenerate the GPF.

In some implementations, the at least one heater comprises (i) an upstream heater associated with an upstream O2 sensor disposed upstream from a catalyst of the GPF in the exhaust system and (ii) a downstream heater associated with a downstream O2 sensor disposed downstream from the catalyst of the GPF in the exhaust system, and the controller is configured to (i) determine the status of the GPF based on duty cycles of the upstream and downstream O2 sensor heaters and (ii) based on the determined GPF status, detect the malfunction of the GPF or whether to regenerate the GPF.

In some implementations, the controller is configured to determine the status of the GPF based on comparison between (a) a ratio of (i) the duty cycle of the upstream heater to (ii) the duty cycle of the downstream heater and (b) a plurality of predetermined ranges of duty cycle ratios corresponding to different load levels and malfunctions of the GPF. In some implementations, the controller is configured to determine the status of the GPF during an engine cold start where the upstream and downstream heaters are active.

In some implementations, the determined GPF status is indicative of one of the following operating conditions: (i) normal operation, (ii) time to regenerate the GPF, (ii) an overloaded GPF, (iv) a burnt-through or cracked GPF catalyst, and (v) an empty GPF can. In some implementations, the controller initiates a regeneration cycle for the GPF when the determined GPF status is indicative of the time to regenerate the GPF. In some implementations, the controller detects the malfunction of the GPF when the determined GPF status is indicative of one of the overloaded GPF, the burnt-through or cracked GPF catalyst, and the empty GPF can. In some implementations, the controller is further configured to set a fault or failure on-board diagnostic (OBD) flag in response to detecting the malfunction of the GPF.

According to another example aspect of the invention, a diagnostic method for a GPF in an exhaust system of a vehicle is presented. In one exemplary implementation, the method comprises: controlling, based on a target temperature, at least one heater associated with at least one O2 sensor disposed proximate to the GPF in the exhaust system, determining, by a controller, a status of the GPF based on a duty cycle of the at least one O2 sensor heater, and based on the determined status of the GPF, detecting, by the controller, a malfunction of the GPF or whether to regenerate the GPF.

In some implementations, the at least one heater comprises (i) an upstream heater associated with an upstream O2 sensor disposed upstream from a catalyst of the GPF in the exhaust system and (ii) a downstream heater associated with a downstream O2 sensor disposed downstream from the catalyst of the GPF in the exhaust system, and the controller is configured to (i) determine the status of the GPF based on duty cycles of the upstream and downstream O2 sensor heaters and (ii) based on the determined GPF status, detect the malfunction of the GPF or whether to regenerate the GPF.

In some implementations, the determining of the status of the GPF is based on comparison between (a) a ratio of (i) the duty cycle of the upstream heater to (ii) the duty cycle of the downstream heater and (b) a plurality of predetermined ranges of duty cycle ratios corresponding to different load levels and malfunctions of the GPF. In some implementations, the determining of the status of the GPF is during an engine cold start where the upstream and downstream heaters are active.

In some implementations, the determined GPF status is indicative of one of the following operating conditions: (i) normal operation, (ii) time to regenerate the GPF, (ii) an overloaded GPF, (iv) a burnt-through or cracked GPF catalyst, and (v) an empty GPF can. In some implementations, the method further comprises initiating, by the controller, a regeneration cycle for the GPF when the determined GPF status is indicative of the time to regenerate the GPF. In some implementations, the method further comprises detecting, by the controller, the malfunction of the GPF when the determined GPF status is indicative of one of the overloaded GPF, the burnt-through or cracked GPF catalyst, and the empty GPF can. In some implementations, the method further comprises setting, by the controller, a fault or failure OBD flag in response to detecting the malfunction of the GPF.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a diagram of an example vehicle according to the principles of the present disclosure;

FIG. 2 is a diagram of an example diagnostic system for a gasoline particulate filter (GPF) according to the principles of the present disclosure;

FIG. 3 is a plot of example oxygen (O2) sensor heater duty cycle ratios for various GPF load levels and malfunctions according to the principles of the present disclosure; and

FIG. 4 is a flow diagram of an example diagnostic method for a GPF of a vehicle according to the principles of the present disclosure.

### DETAILED DESCRIPTION

As discussed above, conventional gasoline particulate filter (GPF) diagnostic system require additional componentry that is expensive and increases vehicle costs. Accordingly, systems and methods are presented that utilize existing vehicle components to perform on-board diagnostic (OBD) monitoring of a GPF for emissions compliance. The techniques described herein monitor one or more heaters associated with upstream and/or downstream oxygen (O2) sensors in the exhaust system. More particularly, these techniques monitor a duty cycle of each of the one or more O2 sensor heaters. The term “duty cycle” refers to a portion of a period in which a particular O2 sensor heater is active. A higher duty cycle is indicative of more heat being drawn away from the heater, which corresponds to a higher exhaust flow rate and lower exhaust back pressure, and vice-versa. A duty cycle above a high threshold is indicative of a malfunction such as a burnt through or cracked catalyst or an empty GPF can (i.e., no catalyst present). Similarly, a duty cycle below a low threshold is indicative of a fully loaded or blocked GPF. Duty cycles therebetween are the target and correspond to normal operation, including normal regeneration scheduling.

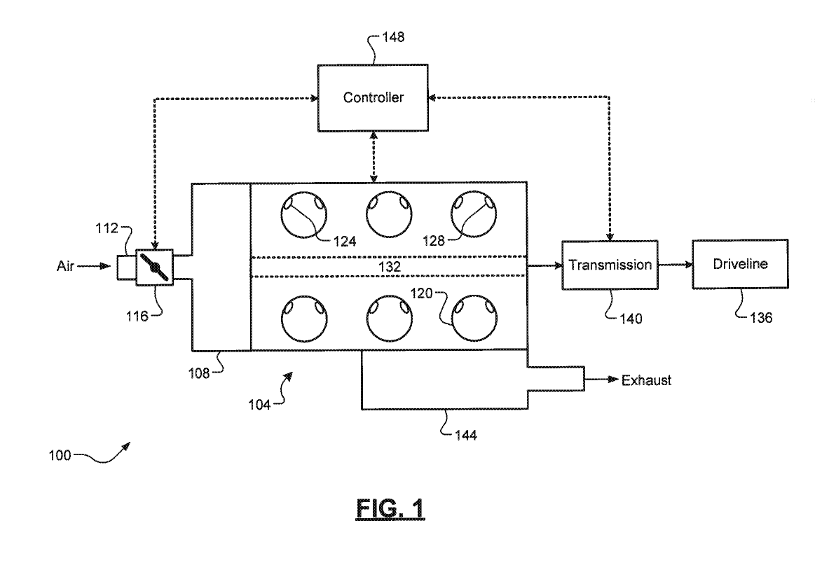

Referring now to FIG. 1, a diagram of an example vehicle 100 is illustrated. The vehicle 100 includes an engine 104 that draws air into an intake manifold 108 through an induction system 112 that is regulated by a throttle valve 116. The air in the intake manifold 108 is distributed to a plurality of cylinders 120 and combined with fuel (e.g., gasoline) from fuel injectors 124 (e.g., via port or direct injection). The air/fuel mixture is compressed by pistons (not shown) and ignited by spark from spark plugs 128 to drive the pistons and generate drive torque at a crankshaft 132. While a spark ignition gasoline engine is illustrated and discussed herein, it will be appreciated that these techniques could be applicable to other engine configurations, such as a diesel engine with a diesel particulate filter (DPF). The drive torque at the crankshaft 132 is transferred to a driveline 136 of the vehicle 100 via a transmission 140. Exhaust gas resulting from combustion is expelled from the cylinders 120 into an exhaust system 144 that treats the exhaust gas to decrease or eliminate emissions. A controller 148 controls operation of the engine 104, including air/fuel/spark control and control/monitoring of the exhaust system 144.

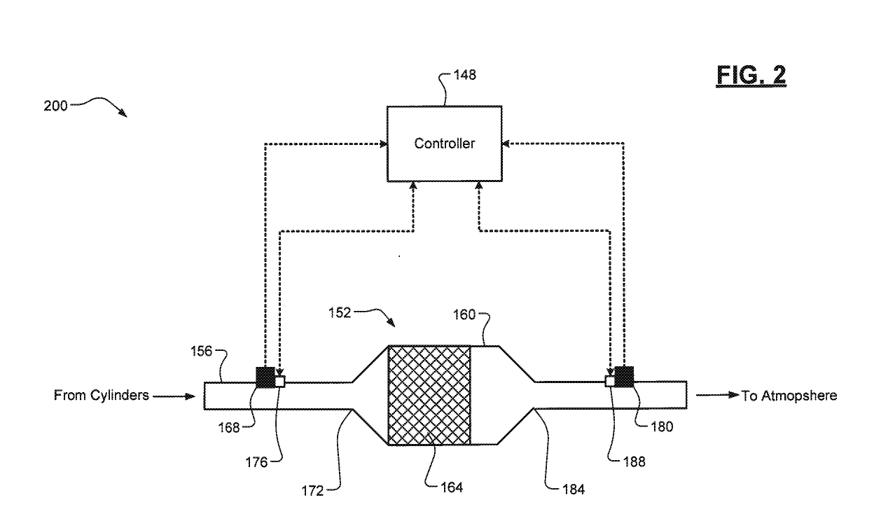

Referring now to FIG. 2, a diagram of a diagnostic system 200 for the exhaust system 144 is illustrated. The exhaust system 144 includes a GPF 152 disposed along an exhaust line 156. The GPF 152 generally comprises a housing or can 160 that houses a catalyst 164. It will be appreciated that the exhaust system 144 could include other components that are not illustrated, such as, but not limited to, an oxidation catalyst, exhaust fuel injectors for GPF regeneration, and a three-way catalytic converter. An upstream O2 sensor 168 is disposed upstream from an inlet 172 of the GPF 152. An upstream heater 176 is associated with the upstream O2 sensor 168 and is configured to heat the upstream O2 sensor 168, such as during engine cold starts for improved measurement accuracy. A downstream O2 sensor 180 is disposed downstream from an outlet 184 of the GPF 152. It will be appreciated, however, that the downstream O2 sensor 180 could alternatively be disposed mid-bed in the GPF 152 between its inlet 172 and its outlet 184 and after the catalyst 164. A downstream heater 188 is associated with the downstream O2 sensor 180 and is configured to heat the downstream O2 sensor 180.

The controller 148 is configured to control/monitor the duty cycles of the upstream and/or downstream heaters 176 and 188. It will be appreciated that the O2 sensors 168, 180 could also control their respective heaters 176, 188 to a calibrated target temperature. The controller 148 is also configured to control regeneration of the GPF 152, which involves controlling the engine 104 and/or exhaust fuel injectors (not shown) to increase the exhaust gas temperature to a temperature that burns off the particulate matter stored in the GPF 152. The OBD GPF diagnostic involves the controller 148 monitoring the duty cycles of the upstream heater 176 and/or the downstream heater 188. A higher duty cycle is indicative of more heat being drawn away from the heater, which corresponds to a higher exhaust flow rate and lower exhaust back pressure, and vice-versa. When the duty cycle indicates that the GPF 152 is full or loaded enough such that regeneration is required, the controller 148 initiates a regeneration cycle. When the duty cycle ratio indicates a malfunction of the GPF 152 (burnt through or cracked, empty can, etc.), the controller 148 sets an OBD fault or failure flag. Detecting this malfunction could also result in the controller 148 taking remedial action, such as commanding a limp-home mode.

In one exemplary implementation, the controller 148 only monitors the duty cycle of the downstream heater 188 and determines the status or state of the GPF 152 based on this monitored duty cycle. In another exemplary implementation, the controller 148 could only monitor the duty cycle of the upstream heater 176 and could determine the status or state of the GPF 152 based on this monitored duty cycle. In yet another exemplary implementation, the controller 148 monitors a ratio of (i) the duty cycle of the upstream heater 176 to (ii) the duty cycle of the downstream heater 178. A higher duty cycle ratio is indicative of more heat being drawn away from the heaters, which corresponds to a higher exhaust flow rate and lower exhaust back pressure, and vice-versa. In this two heater implementation, the duty cycle of the upstream heater 176 acts as a baseline measurement or reference point for the duty cycle of the downstream heater 188. Thus, this duty cycle ratio implementation could be more accurate or precise compared to one of the other implementations that only monitor the duty cycle of one of the upstream heater 176 and the downstream heater 188.

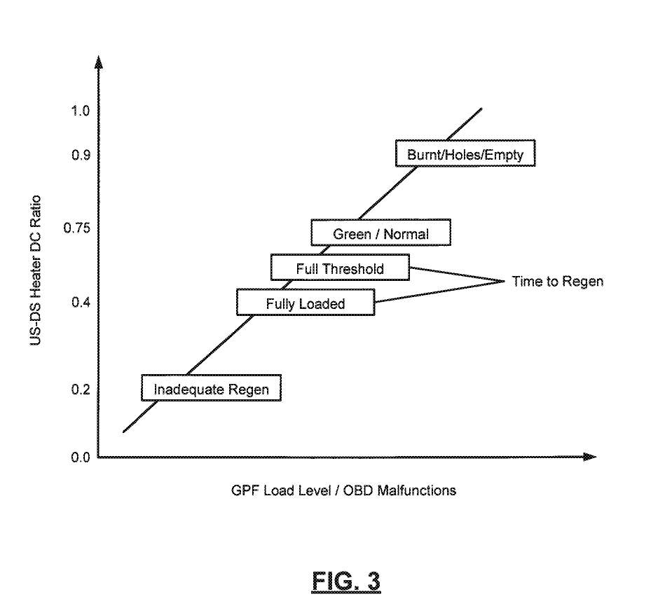

Referring now to FIG. 3, a plot of example O2 sensor heater duty cycle ratios for various GPF load levels and malfunctions is illustrated. It will be appreciated that these duty cycle ratios and corresponding GPF load levels and malfunctions are merely examples and could vary for each particular vehicle application or based on revised emissions standards. The duty cycle ratio as discussed below is defined as a ratio of (i) the duty cycle (DC) of the upstream (US) heater 176 to (ii) the duty cycle (DC) of the downstream (DS) heater 188.

As shown, a normal operating range (“Green”) where the GPF 152 is determined to be operating properly and not requiring regeneration corresponds to duty cycle ratios from ˜0.6 to 0.9. A duty cycle ratio from ˜0.4 (Fully Loaded, e.g., fully loaded with ash) to ˜0.6 (Full Threshold, e.g., fully loaded with soot) is indicative of a time to regenerate the catalyst 164. Regeneration of the catalyst 164, which was previously described, includes increasing the exhaust gas temperature to burn off the particulate matter trapped in the catalyst 164.

A duty cycle ratio of less than ˜0.4 is indicative of an overloaded catalyst 164. A GPF malfunction could be detected when the duty cycle ratio falls below the ˜0.4 duty cycle ratio. Alternatively, the controller 148 could continue trying to regenerate the catalyst 164 until an even lower threshold duty cycle ratio threshold is satisfied, such as a duty cycle ratio of ˜0.2 (Inadequate Regen). Once this lower duty cycle ratio threshold is satisfied, the overloaded GPF malfunction could then be detected.

A duty cycle ratio of ˜0.90 or higher, on the other hand is indicative of one of two other GPF malfunctions: a burnt-through (e.g., a hole) or cracked catalyst 164 or an empty can 160 (i.e., no catalyst 164). The first malfunction could occur, for example, when the catalyst 164 is exposed to extreme high temperatures for extended periods of time. The second malfunction could occur, for example, when the GPF 152 is incorrectly assembled without the catalyst 164 or when the catalyst 164 is removed from the can 160.

To summarize, there is an expected exhaust flow during normal operation of the GPF 152, including regeneration cycles of the catalyst 164. When the exhaust flow increases due to a hole/crack in or lack of the catalyst 164, the downstream heater duty cycle increases substantially. Conversely, when the exhaust flow decreases due to an overloaded catalyst 164 that is unable to be successfully regenerated back to the normal operating range, the downstream heater duty cycle decreases substantially.

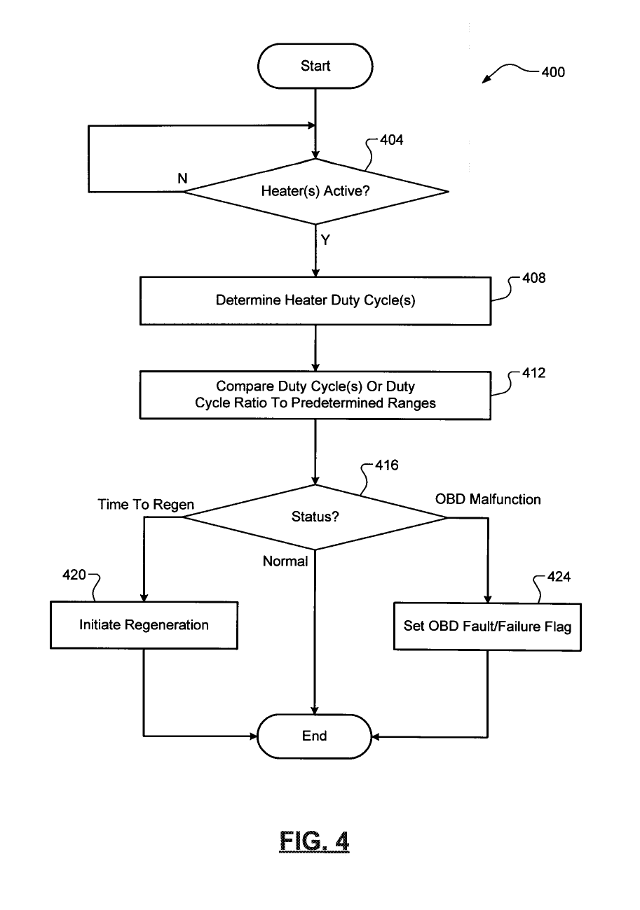

Referring now to FIG. 4, a flow diagram of an example diagnostic method 400 for the GPF 152 of the vehicle 100 is illustrated. For purposes of simplicity, the term “heater(s)” as used below will refer to the upstream heater 176 and/or the downstream heater 188. At 404, the controller 148 determines whether the heater(s) are active. For example, the heater(s) could be active during a cold start of the engine 104 in order to heat the respective O2 sensor probes for improved measurement accuracy. In one exemplary implementation, this method 400 is performed on each engine startup event. When the heater(s) are not active, the method 400 ends or returns to 404. When the heater(s) are active, the method 400 proceeds to 408. At 408, the controller 148 determines the duty cycle(s) of the heater(s).

At 412, the controller 148 compares the duty cycle(s) or a duty cycle ratio to predetermined ranges corresponding to various GPF load levels and OBD malfunctions. At 416, the controller 148 determines the status of the GPF based on the comparison. When the status is normal, the method 400 ends or returns to 404. When the status is time to regenerate, the controller 148 initiates a regeneration cycle for the catalyst 164 at 420 and the method 400 ends or returns to 404. When the status is one of the three OBD malfunctions (overloaded, hole/crack, empty can), the controller 148 sets an OBD fault or failure flag at 424 and the method 400 ends or returns to 404. It will be appreciated that step 424 could also include remedial engine control, such as commanding a limp-home mode as previously described herein.

It will be appreciated that the term “controller” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A diagnostic system for a gasoline particulate filter (GPF) of an exhaust system of a vehicle, the system comprising:
at least one heater associated with at least one oxygen (O2) sensor disposed proximate to the GPF in the exhaust system; and
a controller configured to:
determine a status of the GPF based on a duty cycle of the at least one O2 sensor heater; and
based on the determined status of the GPF, detect a malfunction of the GPF or whether to regenerate the GPF.

2. The system of claim 1, wherein
the at least one heater comprises (i) an upstream heater associated with an upstream O2 sensor disposed upstream from a catalyst of the GPF in the exhaust system and (ii) a downstream heater associated with a downstream O2 sensor disposed downstream from the catalyst of the GPF in the exhaust system; and
the controller is configured to (i) determine the status of the GPF based on duty cycles of the upstream and downstream O2 sensor heaters and (ii) based on the determined GPF status, detect the malfunction of the GPF or whether to regenerate the GPF.

3. The system of claim 2, wherein the controller is configured to determine the status of the GPF based on comparison between (a) a ratio of (i) the duty cycle of the upstream heater to (ii) the duty cycle of the downstream heater and (b) a plurality of predetermined ranges of duty cycle ratios corresponding to different load levels and malfunctions of the GPF.

4. The system of claim 2, wherein the controller is configured to determine the status of the GPF during an engine cold start where the upstream and downstream heaters are active.

5. The system of claim 1, wherein the determined GPF status is indicative of one of the following operating conditions: (i) normal operation, (ii) time to regenerate the GPF, (ii) an overloaded GPF, (iv) a burnt-through or cracked GPF catalyst, and (v) an empty GPF can.

6. The system of claim 5, wherein the controller initiates a regeneration cycle for the GPF when the determined GPF status is indicative of the time to regenerate the GPF.

7. The system of claim 5, wherein the controller detects the malfunction of the GPF when the determined GPF status is indicative of one of the overloaded GPF, the burnt-through or cracked GPF catalyst, and the empty GPF can.

8. The system of claim 7, wherein the controller is further configured to set a fault or failure on-board diagnostic (OBD) flag in response to detecting the malfunction of the GPF.

9. A diagnostic method for a gasoline particulate filter (GPF) in an exhaust system of a vehicle, the method comprising:
controlling, based on a target temperature, at least one heater associated with at least one oxygen (O2) sensor disposed proximate to the GPF in the exhaust system;
determining, by a controller, a status of the GPF based on a duty cycle of the at least one O2 sensor heater; and
based on the determined status of the GPF, detecting, by the controller, a malfunction of the GPF or whether to regenerate the GPF.

10. The method of claim 9, wherein:
the at least one heater comprises (i) an upstream heater associated with an upstream O2 sensor disposed upstream from a catalyst of the GPF in the exhaust system and (ii) a downstream heater associated with a downstream O2 sensor disposed downstream from the catalyst of the GPF in the exhaust system; and
the controller is configured to (i) determine the status of the GPF based on duty cycles of the upstream and downstream O2 sensor heaters and (ii) based on the determined GPF status, detect the malfunction of the GPF or whether to regenerate the GPF.

11. The method of claim 10, wherein the determining of the status of the GPF is based on comparison between (a) a ratio of (i) the duty cycle of the upstream heater to (ii) the duty cycle of the downstream heater and (b) a plurality of predetermined ranges of duty cycle ratios corresponding to different load levels and malfunctions of the GPF.

12. The method of claim 10, wherein the determining of the status of the GPF is during an engine cold start where the upstream and downstream heaters are active.

13. The method of claim 9, wherein the determined GPF status is indicative of one of the following operating conditions: (i) normal operation, (ii) time to regenerate the GPF, (ii) an overloaded GPF, (iv) a burnt-through or cracked GPF catalyst, and (v) an empty GPF can.

14. The method of claim 13, further comprising initiating, by the controller, a regeneration cycle for the GPF when the determined GPF status is indicative of the time to regenerate the GPF.

15. The method of claim 13, further comprising detecting, by the controller, the malfunction of the GPF when the determined GPF status is indicative of one of the overloaded GPF, the burnt-through or cracked GPF catalyst, and the empty GPF can.

16. The method of claim 15, further comprising setting, by the controller, a fault or failure on-board diagnostic (OBD) flag in response to detecting the malfunction of the GPF.
